(19) United States
(12) Patent Application Publication
(10) Pub. No.: US 2006/0002748 A1
(43) Pub. Date: Jan. 5, 2006

(54) Mark forming method, mark formed moving member and image forming apparatus

(76) Inventors: Koichi Kudo, Yokohama-shi (JP); Yasufumi Yamada, Yokohama-shi (JP); Takuro Kamiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/169,780

(22) Filed: Jun. 30, 2005

(30) Foreign Application Priority Data
Jul. 1, 2004 (JP) 2004-195138

(51) Int. Cl. G03G 15/01

(52) U.S. Cl. 399/302

(57) ABSTRACT

A moving member includes a first layer that blocks a light having a first wavelength and absorbs or allows transmission of a light having a second wavelength different from the first wavelength. A second layer is provided to absorb the light having the first wavelength and reflect the light having the second wavelength. A third layer is provided to allow transmission of the lights having the first and second wavelengths. The first to third layers are laminated on the moving member in this order.

### CROSS REFERRENCE TO RELATED APPLICATION

This application claims priority under 35 USC § 119 to Japanese Patent Application No. 2004-195138 filed on Jul. 1, 2004, entire contents of which are herein incorporated by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates to a moving member, an image forming apparatus, and a method of forming a mark on the moving member, and in particular, to a moving member, such as a photo-conductive belt, an intermediate transfer belt, a sheet conveyance belt, a photo-conductive drum, a transfer drum, etc., used in image formation and an image forming apparatus that includes the moving member.

2. Discussion of the Background Art

First, configurations and operations of various background belts, drums, members, and image forming apparatuses are generally described with reference to FIG. 12. A background color image forming apparatus 100 sometimes is a tandem type that includes a plurality of image formation units 1K, 1M, 1Y, and 1C arranged one after another in a moving direction as shown by an arrow A from upstream along with the conveyance belt 3 that conveys a transfer sheet 2. These units 1K, 1M, 1Y, and 1C form respective images of black, magenta, yellow, and cyan. These image formation units have the same configuration except for a color. Thus, the image formation unit 1K is hereinafter typically described.

The conveyance belt 3 is formed from an endless belt suspended by a driving roller 5 and a driven roller 4 to freely rotate. A sheet feeding tray 6 is arranged below the conveyance belt 3 to accommodate a plurality of sheets 2. Among the sheet 2, the upper most one is launched to form an image and is attracted by the outer surface of the conveyance belt 3 with electrostatic force. The sheet 2 on the conveyance belt 3 is conveyed to the image formation unit 1K arranged most upstream in the rotational direction.

The image formation unit 1K is formed from a photo-conductive drum 7K, a charger 8K, an exposure 9K, a developing device 10K, a photo-conductive cleaner 11K, and the like. The exposure 9K employs a laser scanner to reflect and launch a laser beam from a light source using a polygonal mirror via an optical system employing a Fθ (theta) lens and a deviation mirror or the like. When an image is formed, the surface of the photo-conductive drum 7K is uniformly charged by the charger 8K in the dark, and is then exposed by the exposure light 12K (i.e., a laser light) for a black image, irradiated from the exposure 9K, thereby a latent image is formed. The latent image is visualized by the developing device 10K with black toner and a black toner image is thereby formed on the photoconductive drum 7K. The black toner image is transferred by a transfer charger 13K onto a sheet 2 on the conveyance belt 3 at a contact position, thereby a mono-color (i.e., black) image is formed thereon. The photoconductive drum 7K is ready to execute the next image formation when the photoconductor cleaner 44K remove unnecessary toner remaining on the surface of the photoconductive drum 7K.

Then, the sheet 2 having the mono-color black is conveyed by the conveyance belt 3 from the image formation unit 1K to the next image formation unit 1M. A magenta toner image is then formed on the photoconductive drum 7M by the same process as in the image formation unit 1K, and is transferred and superimposed on the black toner image on the sheet 2. The sheet 2 having the black and magenta toner images is transferred to the next image formation unit 1Y. A yellow toner image is then formed on the photo-conductive drum 7Y by the same process as in the image formation unit 1Y, and is transferred and superimposed on the black and magenta toner image formed on the sheet 2. Similarly, a yellow toner image is formed on the photo-conductive drum 7Y by the same process as in the image formation unit 1Y, and is transferred and superimposed on the black and magenta toner image formed on the sheet 2. The sheet with full-color superposition image is formed when completing the similar image formation in the image formation unit 1C, and is ejected after receiving fixation from a fixing device 14, and being separated from the conveyance belt 3.

Although so-called a direct transfer system is described heretofore, an intermediate transfer system can be employed in which a full-color image is temporary formed on an intermediate transfer belt before transferring respective color images onto a sheet. Such an intermediate transfer system can obtain a fine image, because the intermediate transfer belt is commonly used when forming respective mono color images, and does not vary in a thickness or a moisture absorption performance as being different from a sheet.

However, due to various errors in a distance between respective axis of photo-conductive drums, and a parallel level of the photo-conductive drum, a line speed of the photo-conductive drum or the like, toner images tends to deviate at a prescribed target position. As a result, color deviation occurs. As factors causing such positional deviation, skew caused by poor alignment of inclinations of scanning lines of respective colors (i.e., oblique deviation), sub-scanning registration deviation in which positions of respective images deviate in a sheet conveyance direction, unevenness of a sub-scanning line pitch, main-scanning registration deviation in which either a write start or end position deviates in a main scanning direction are exemplified.

Thus, as shown in FIG. 13, a positioning error caused by speed variation in a belt conveying apparatus of a conventional color image forming apparatus shows a waveform having a plurality of frequency components due to variation in a thickness of a belt, eccentricity of a roller, and unevenness of speed of a driving motor. Thus, positions of respective colors of superimposed images formed during positional variance do not coincide on an output image as shown in FIG. 14. Thus, an image is outputted with their positions being deviated. Accordingly, the positional error is one of reasons for deterioration of image quality, such as color displacement, color transition, etc.

In order to highly precisely adjust by avoiding such a positional deviation, a conventional apparatus employs the below described technology. That is, a rotary encoder is directly connected to a rotational shaft of a driving roller that drives an endless belt type moving member (i.e., a rotation member), such as a transfer belt, a sheet conveyance belt, etc., or that of a cylindrical member, such as a photo-conductive drum, etc., to control an angular speed of a driving motor that rotates the driving roller in accordance with a rotational angular speed of the rotation member detected by the rotary encoder. For example, an image forming apparatus discussed in Japanese Patent Application Laid Open No. 6-175427 indirectly controls a moving amount or position by controlling a rotational angular speed of the rotation member. Further, in Japanese Patent application Laid Open Nos. 6-263281 and 9-114348, a driving apparatus for an endless belt is discussed. Specifically, a mark 21 is formed on a surface of a belt 20 and is detected by a sensor 21 to generate pulses. After that, a belt surface speed is calculated from an interval of the pulses and is fed back for controlling as illustrated in FIG. 15. According to this system, a moving amount can be directly controlled, because a behavior of the belt surface can be directly monitored.

However, none of the applications specifically discloses a method of forming a mark on a belt, and do not resolve a problem raised when it is practically used. There is indeed a technique of forming an aperture on a belt as a mark detected by a transmission type sensor. However, when the aperture is formed, tension strength of the belt significantly deteriorates at the aperture section, and a stretching amount thereof is larger than the other sections, thereby a belt conveyance condition cannot be precisely monitored. In addition, clack appears due to concentration of stress thereto and the belt itself is possibly broken starting from the mark aperture section. Further, when either a mark aperture or a reflection mark of a metal reflection film is employed, leak current appears on a photo-conductive member or an intermediate transfer belt due to subjection to a high electric field, thereby a transfer process receives ill influence resulting in a malfunction of a machine. Then, according to the above-mentioned Japanese Patent Application Laid Open No. 2004-99248, an endless belt conveying apparatus employs a surface protection layer for a mark to avoid damage caused by contact from a roller and a cleaning blade or the like. Thus, strength deterioration caused by forming the mark can be recovered while suppressing an error in a pitch between marks when forming the mark protection layer. However, in such a Japanese Patent Application Laid Open No. 2004-99248, adhesive arranged below a metal layer is damaged by heat during a laser process when the laser process is executed though the protection layer that is coated before hand to avoid later application thereto. Otherwise, a processing use laser also damages a base member of a belt when the adhesive has a high transparency.

### SUMMARY

Accordingly, an object of the present invention is to address and resolve such and other problems and provide a new and novel moving member having a base layer. The moving member includes a first layer that blocks a light having a first wavelength and allows transmission of a light having a second wavelength different from the first wavelength, a second layer that absorbs the light having the first wavelength and reflects the light having the second wavelength, and a third layer that allows transmission of the lights having the first and second wavelengths. Further, the first to third layers are laminated on the base layer in this order.

In another embodiment, the first wavelength ranges within an ultraviolet region, and the second wavelength ranges from a visible region to an infrared region longer than the ultraviolet region.

In yet another embodiment, the light having the first wavelength includes irradiation intensity enables the second layer one of to melt, to change characteristics, to modify a property, and to change a shape.

In yet another embodiment, the first layer includes adhesive having viscoelasticity capable of securing the second and third layers to the base layer.

In yet another embodiment, the first layer includes adhesive of an acrylic or a silicon type.

In yet another embodiment, the second layer includes a thin reflection coat made of metal.

In yet another embodiment, the second layer includes an aluminum thin coat having thickness less than 200 nanometers.

In yet another embodiment, the third layer includes a plastic film configured to allow transmission of the light having the first wavelength.

In yet another embodiment, the third layer includes a PET (polyethylene terephtharate) film.

In yet another embodiment, the base layer includes one of a polyimide film and a composition adjusted polyimide film.

In yet another embodiment, a reflectivity of said metal thin layer of the second layer is changed by low temperature damaging upon receiving a light having the first wavelength of from 300 nanometer to 400 nanometer with a pulse width less than 100 nanometer.

In yet another embodiment, the first layer has one of characteristics of absorbing and blocking a light having wavelength from 300 to 400 nanometers, and allows transmission of a light having a wavelength of from 600 nanometer to 900 nanometer.

In yet another embodiment, the second layer is processed by the light having the first wavelength to allow transmission of the light having the second wavelength.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates an exemplary layer structure of a moving member;

FIG. 2 illustrates an exemplary mark of a slit pattern formed at a constant interval;

FIG. 3 illustrates an exemplary construction of a driving apparatus that drives the moving member according to one embodiment of the present invention;

FIG. 4 illustrates an exemplary relation between a transmittance and a wavelength;

FIG. 5 illustrates an exemplary relation between a light penetration depth and a wavelength;

FIG. 6 illustrates an exemplary endless belt of the moving member of the first embodiment;

FIGS. 7A and 7B collectively illustrate an exemplary process for forming an optical slit;

FIG. 8 illustrates an exemplary mark forming optical system;

FIG. 9 illustrates an exemplary practical optical slit pattern;

FIG. 10 illustrates an exemplary light reflectivity property of the optical slit;

FIG. 11 illustrates an exemplary digital copier according to another embodiment of the present invention;

FIG. 12 illustrates a background color image forming apparatus;

FIG. 13 illustrates a wavelength of a positioning error caused by variation in a speed of a belt conveying apparatus;

FIG. 14 illustrates positional variations of an output image per mono color, which are caused by positional variation of the endless belt; and

FIG. 15 illustrates a driving apparatus for the endless belt.

### PREFERRED EMBODIMENTS OF THE PRESENT INVENTION

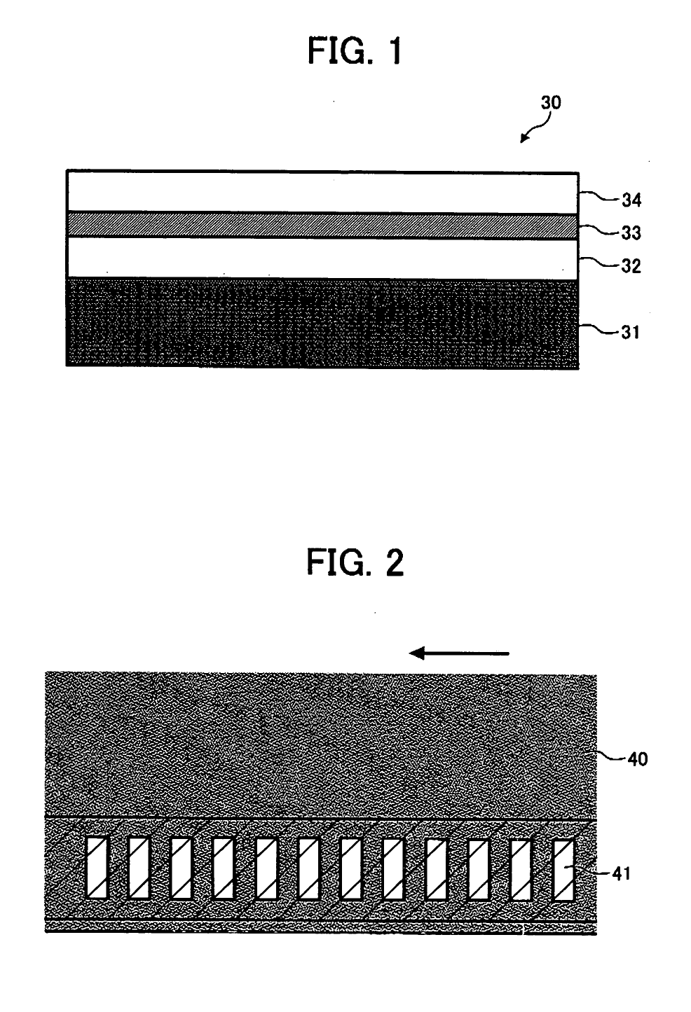

Referring now to the drawing, wherein like reference numerals designate identical or corresponding parts throughout several views, in particular in FIG. 1, a moving member 30 of one embodiment is formed from a first layer 32 that overlies a base layer 31 and blocks a light having a first wavelength and absorbs or allows transmission of a light having a second wavelength different from the first wavelength. A second layer 33 overlies the first layer 32 and absorbs the light having the first wavelength and reflects the light having the second wavelength. Also forming the moving member 30 is a third layer 34 that overlies the second layer 33 and allows transmission of the lights having the first and second wavelengths. When the light having the first wavelength is emitted from above the third layer 34, the second layer 33 is melted and changes own characteristics and quality, thereby a mark having a different reflectivity against the light having the second wavelength is formed. The light of the first wavelength has a prescribed irradiation intensity enabling the second layer 33 to melt, change quality and a shape, and form a mark. The light of the second wavelength is used to detect a mark. The first layer 32 functions as an adhesive layer to secure the second and third layers 33 and 34 to the base layer 31. The second layer 33 functions as a mark layer that is processed by the light having the first wavelength and changes reflectivity reflecting the light having the second wavelength. The third layer 34 functions as a surface protection layer.

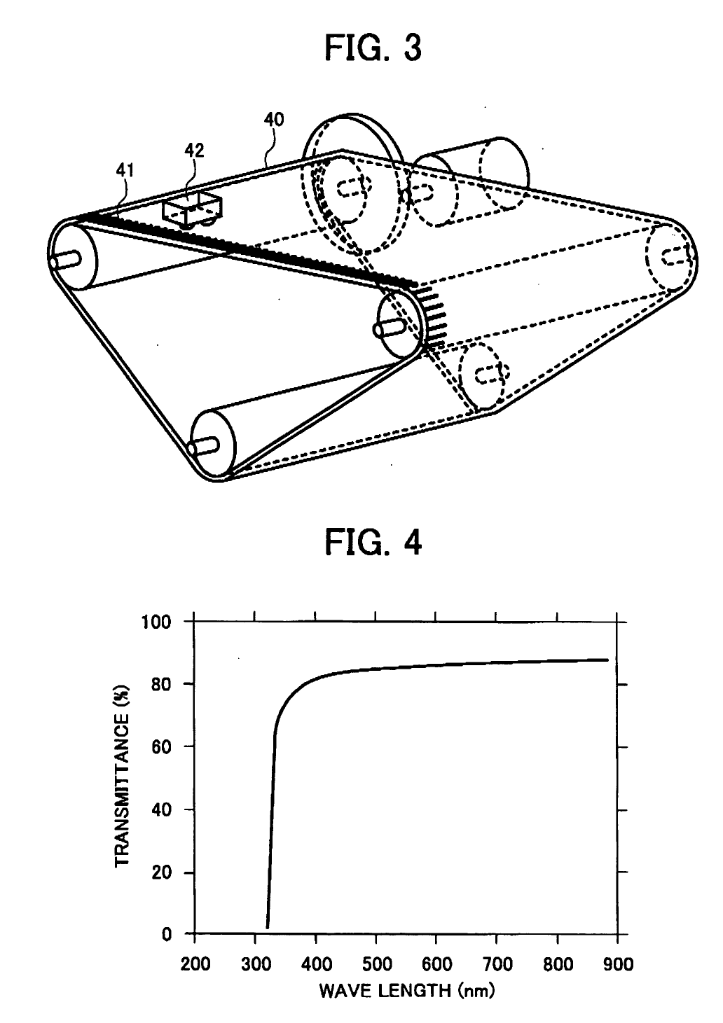

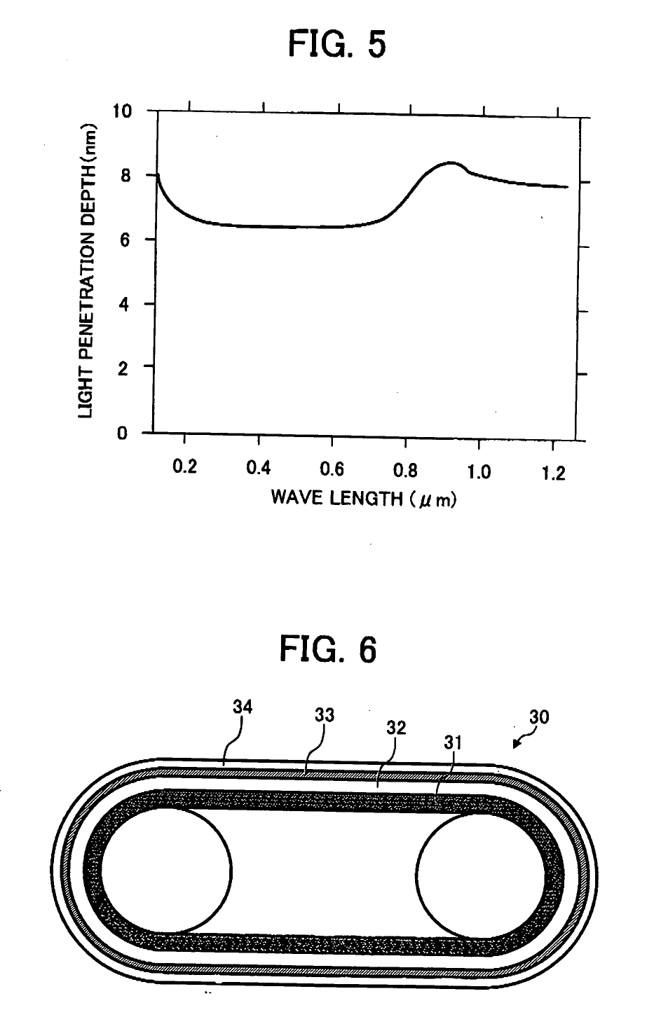

A plurality of reflection marks can be employed and employ every shape. As shown in FIG. 2, when a plurality of pattern marks 41 of a slit shape are formed at the same interval and a speed of the moving member is detected, a signal varying an output frequency in accordance with the rotation speed can be detected. As shown in FIG. 3, if a reflection type mark 41 is partially arranged on the surface of the endless belt type moving member 40, a reflection type sensor 42 can read the mark 41. The light having the first wavelength can employ a laser light.

Since the third layer 34 allows transmission of the light having the first wavelength, and the second layer 33 absorbs the light to the contrary, the second layer 33 is preferably composed of material causing a change in reflectivity in response to an irradiation laser light. The laser light can partially have a significantly high energy density if being focused. Changing a melting manner, a quality, and a shape in accordance with the energy can change the reflectivity. For example, if heat energy is utilized, thermal material that changes color by heat or plastic or metal that melts and changes a shape can be utilized. The laser processing system can internally have a processing position. Further, an irradiation region of the laser light can be readily adjusted in minute detail up to a micron order if using a lens and a mirror or the like.

Thus, when a processing use light having the first wavelength is selected as a light source, a significantly high energy is injected into the second layer 33. In general, in order to form a highly precise mark, a thickness of the second layer 33 is necessarily decreased so that the emitted energy does not expand. Because, sharpness is in proportion to diffusion of energy. As the second layer 33 becomes thinner, a transmittance of the laser light becomes higher, and thereby, a possibility of leakage of the light from the first layer 32 increases. When material of the base layer 31 tends to easily melt and change quality and a shape when receiving a light having the first wavelength, the material is damaged by the leakage of the processing use light. However, since the first layer 32 of this embodiment has a performance to block a light having the first wavelength, such a problem can be suppressed. By arranging the base layer 31 below the first layer 32 while optically detecting a mark, a moving condition can be detected.

An intermediate transfer belt employed in an electro-photographic system such as a printer can be a typical moving member. The intermediate transfer belt generally includes dispersion of carbon so as to adjust a resistance and has a performance to convey and transfer a toner image. Thus, many of intermediate transfer belts have almost a black color and made of fluorinated plastic, such as PVDF, ETFE, etc. However, Polyimide (PI) based member having high intensity is increasingly used to decrease deformation of an image due to belt expansion and contraction so as to increase durability, recently. The polyimide largely absorbs a relatively long wavelength, and is easy to execute abrasion processing using a pulse laser. Thus, the PI is easily damaged by leakage of the processing use laser light, and a belt deteriorates. In addition, an adhering force to a mark material significantly deteriorates as a problem. Then, the first wavelength ranges within an ultraviolet light region. The second wavelength ranges from visible to infrared regions, which is longer than that of the ultraviolet light. A short pulse width (e.g. a few hundreds nanometer) laser such as an Excimer laser, a YAG laser, a Ti sapphire laser, etc., is preferably employed for a processing use laser to suppress heat generation at a mark section.

Further, when a laser is focused, a short wavelength enables higher focusing and creating highly fine marks. However, when the wavelength is excessively short, polymeric material comes to have an absorption performance. When polymeric material such as PET, PC, etc., allowing a light of up to a relatively short wavelength is utilized, a higher harmonic wavelength of 355 nm as three times as that of YAG is preferable as shown in FIG. 4.

Further, a wavelength region, such as 532 nm as twice as a radio frequency of the YAG, a basic wave 1064 nm, etc., falls within a transmission region for a polymer molecule film, and enables removal of an aluminum deposition coat. However, since it is a transmission wavelength for an adhesive member, the base member is damaged. If an LED is employed as a light source, a sensor wavelength becomes preferably near an infrared wavelength region, such as 850 nm to 900 nm. Because, emission is highly effective and a disturbance light is readily removed by a filter. A typical polymer molecule film represents a high reflectivity when reflecting from an aluminum deposition coat in a transmission region. Thus, the third layer 34 is made of a plastic film, which allows transmission of an ultra violet light of a first wavelength in a transmission region. The second layer 33 is preferably a reflection film formed from a metal thin film. Performances expected to the second and third layers 33 and 34 include transparency of the third layer 34 for both a process laser wavelength and a sensor wavelength, a prescribed intensity, and prescribed Young's modules. Further, the second layer 33 is thin as becoming transparent during processing and has an absorption performance. Further, the second layer 33 is preferably processed by a processing use laser, and reflects the light having the sensor wavelength. Thus, if belt like polyimide is employed as a base layer 31, PET is used as a third layer 34. Because, the PET has prescribed Young's modules close to polyimide, a reinforcing intensity, and a transparence performance in relation to an ultraviolet light, and highly commercially availability.

As a reflection use metal of the second layer 33, aluminum is typically used, and a PET film with aluminum deposition is also highly available due to mass production. However, since a light penetration depth is less than 10 nm, kind of reflectivity is obtained. Thus, a thin film is preferably used. If an ultraviolet pulse laser executes a process, a film thickness is preferably 20 nm to 200 nm to avoid generation of heat during processing and obtain sufficient reflectivity when reflecting an optical system sensor.

Further, the first layer 32 is made of an adhesive, for example. Thus, when mark material made of the above-mentioned plastic film or a metal thin film and the like is attached onto the base layer 31, a typical curing type adhesive creates a bent due to winding around a roller during a belt conveyance as shown in FIG. 6. As a result, a mark section possibly peels off, and an adhesive having viscoelasticity is to be utilized. Further, since a typical acrylic type adhesive has a performance to absorb an ultraviolet light, and has a small heat resistance, a silicon series having a large amount of heart resistance is preferably used as an adhesive of the first layer 32, when a process needs heat. The acrylic series is employable if a process generates relatively less amount of heat as described below. In view of maintaining precision of a mark, a thin adhesive member having larger shearing stress, tack strength, and hardness is preferably utilized.

Further, a light source that generates a light having the first wavelength to form a mark preferably has a wavelength of from 300 to 400 nm with a pulse width of less than 100 ns. The light source preferably changes a reflectivity of a metal thin film of the second layer 33 using a large intensity laser light while suppressing heat damage. Further, the first layer 32 preferably has a performance to absorb or block a light having a wavelength of from 300 nm to 400 nm, and transmit or scatter a light having a wavelength of from 600 nm to 900 nm. Further, a thickness of the metal thin film of the second layer 33 is less than 200 nm. The metal thin film is processed by a short pulse laser having the first wavelength to have a transmission performance for a light having the second wavelength. According to one embodiment of the present invention, a short pulse laser having a pulse width less than 200 ns is used as a processing use laser light, and either removes or moves a reflection material layer while suppressing heat damage.

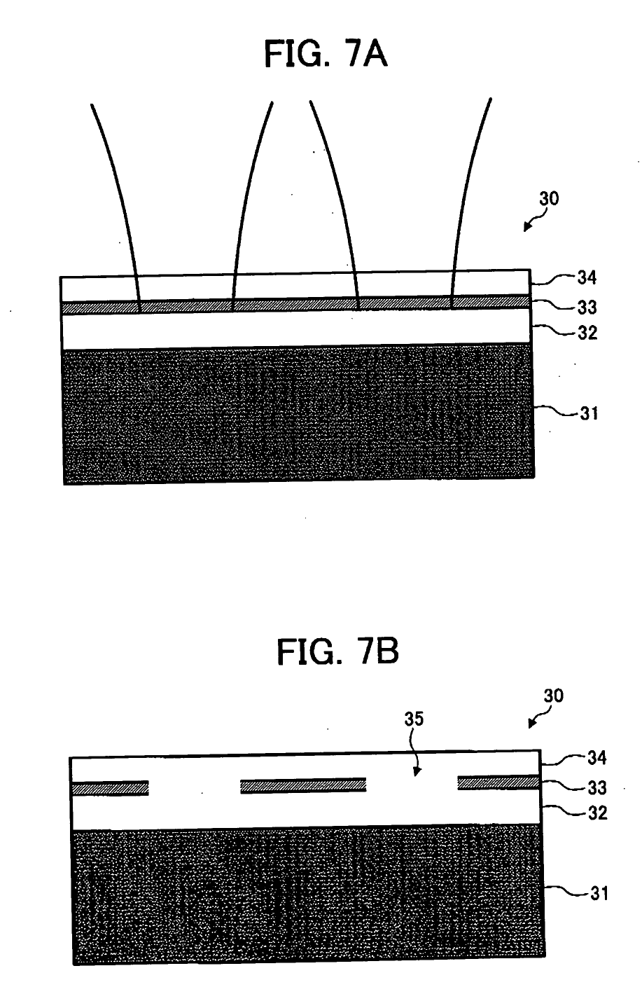

A manner of processing an optical slit is illustrated in FIG. 7. As shown, the second layer 33 formed from a high reflectivity material, such as AL, Ni, etc., is arranged on the surface of the base layer 31, either directly or via the first layer 32 as a transparent polymer molecule film to be a mark after processing. The second layer 33 has a sufficient intensity and detectable by the optical sensor 42 at a depth of from about 50 nm to about 100 nm. The second layer 33 can be readily formed by means of spattering and depositing manners or the like.

The above-mentioned processing use laser uses a pulse width less than 200 ns. The laser employs an Excimer laser, a Q-Switch Nd (YAG) laser, a higher harmonic laser, a Ti (sapphire) laser with a plus width of several hundred femtoseconds, and the like. It is known that when these lasers are emitted to the surface of the second layer 33, a material layer is removed at high speed due to absorption of the film. Since a pulse width is fine, heat damage can be suppressed when the material layer is removed. Thus, a highly precise processing can be executed while obtaining a fine edge shape at a processing section. Further, a mark can be fine, because these lasers can be suppressed to expand their shape, which is generally caused by heat conduction. Further, when the femtosecond region laser is utilized, a quality change region can be a sub micron order even if a metal member having large heat conductivity is used. Thereby, deformation or the like possibly caused at a circumference of the processing section can be suppressed.

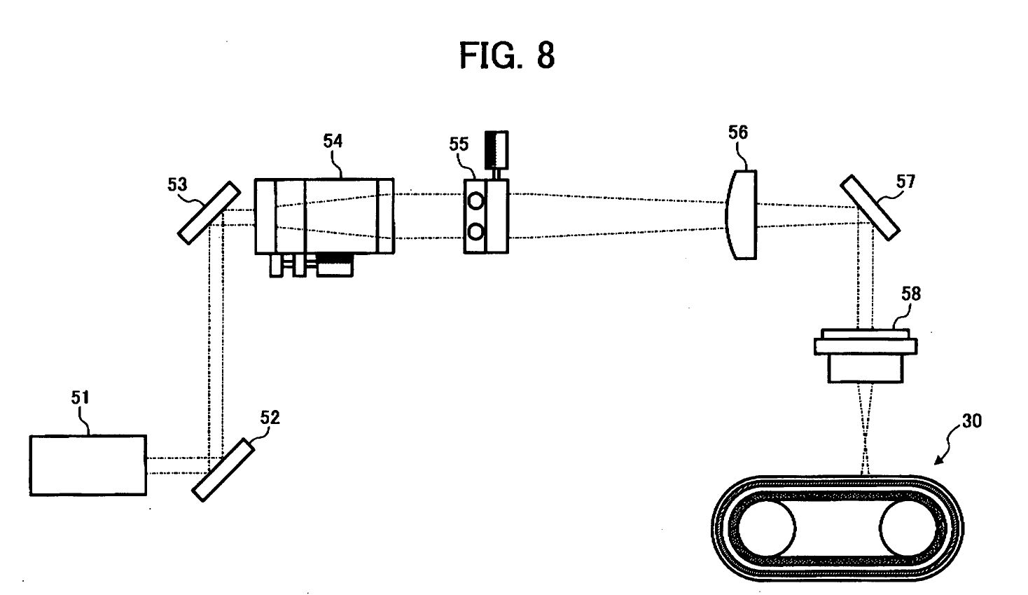

FIG. 8 illustrates an exemplary mark forming optical system. As shown, a laser apparatus 51 employs a third higher harmonic wave of a Nd (YAG) laser, for example. A laser light emitted by the laser apparatus 51 is led to an expansion optical element 54 by mirrors 52 and 53. The laser is then led to a focussing lens 58 by a fairing optical element 55, a cylindrical lens 56, and a mirror 57. The laser light is then faired in a line state by a focussing optical element or the like, and is emitted to the surface of the second layer 33 via the third layer 34 as a processing objective. By continuously moving a position of the surface while controlling emission timing of a laser light, a slit pattern can be continuously formed on the surface of the endless belt.

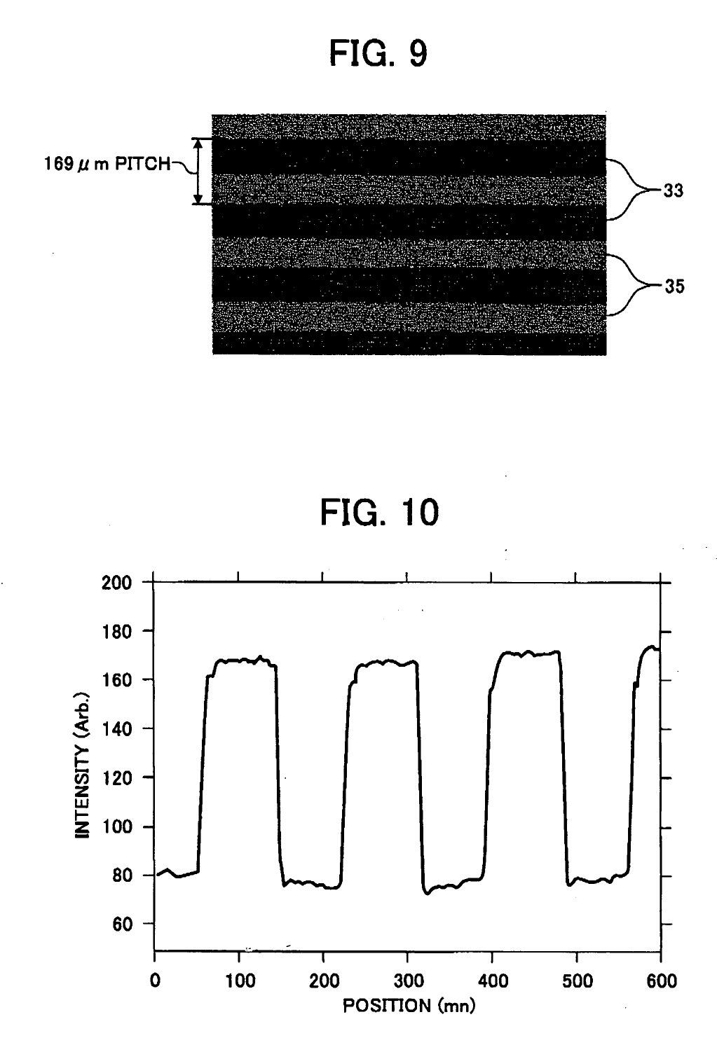

FIG. 9 illustrates an exemplary pattern of a practically obtained optical slit. As shown, the second layer 33 made of aluminum and located below the PET film absorbs energy and separates binding when a nanosecond laser is emitted thereto while intensity is adjusted. Since the energy creates optically undetectable fine particles of less than few hundred manometers or defuses the aluminum, the second layer 33 loses a reflection performance at the laser emission section, thereby an optical slit pattern is formed thereon.

FIG. 10 illustrates an exemplary light reflectivity of the slit. As understood therefrom, a change in reflectivity can be measured even in an optical slit 35 a shown in FIG. 9, which is formed inside the third layer 34. Thus, a position of a rotation member can be detected by detecting the optical slit 35 using an optical detecting device. A pitch between optical slits can be adjusted by continuously changing a position of laser emission. Further, since a laser lighting process does not require a heating process, material weak to heat, such as a belt, etc., and that difficult to execute a solvent processing such as a photo-conductive member can be processed. Further, since the laser process is a non-contact type, deformation and deterioration of a function of the material caused by laser light emission can be suppressed.

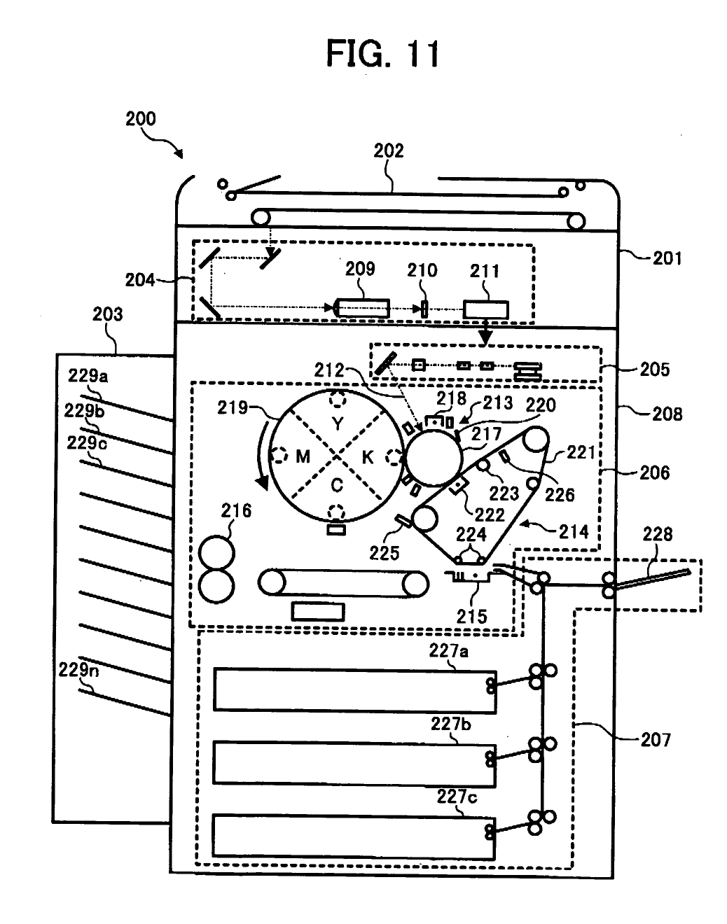

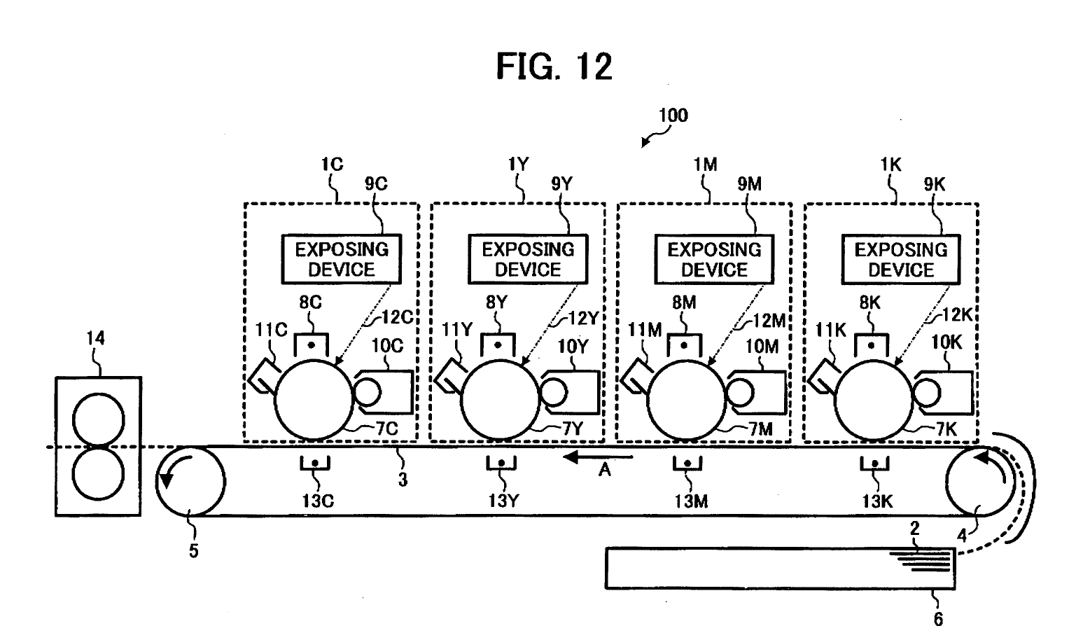

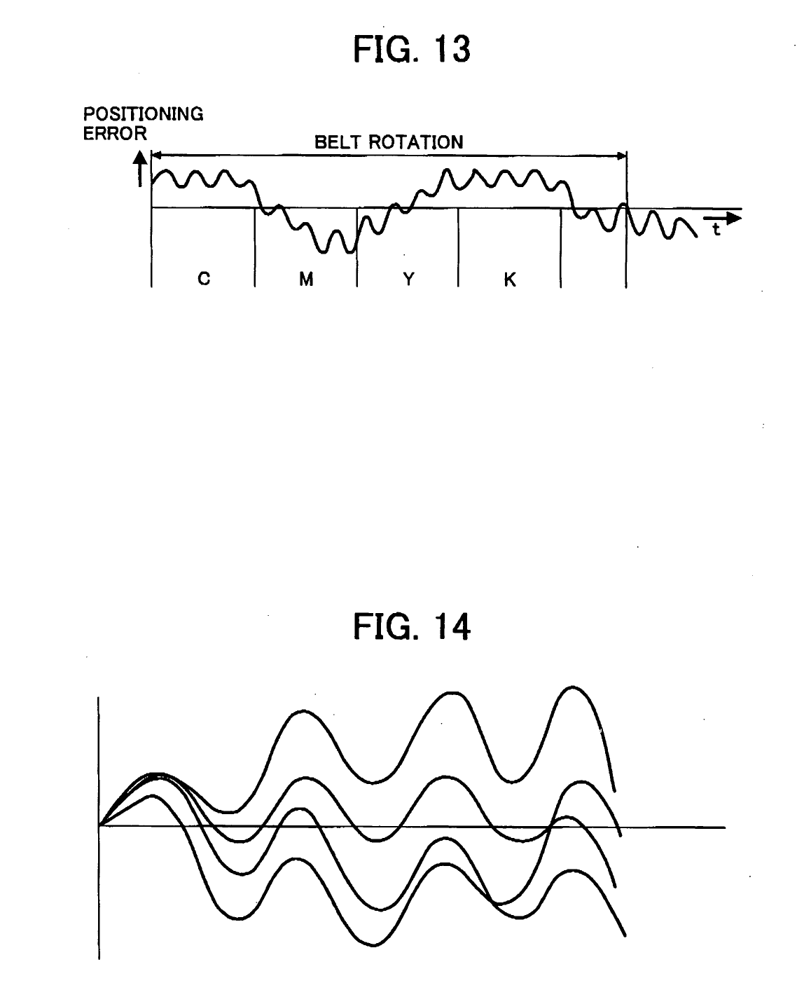

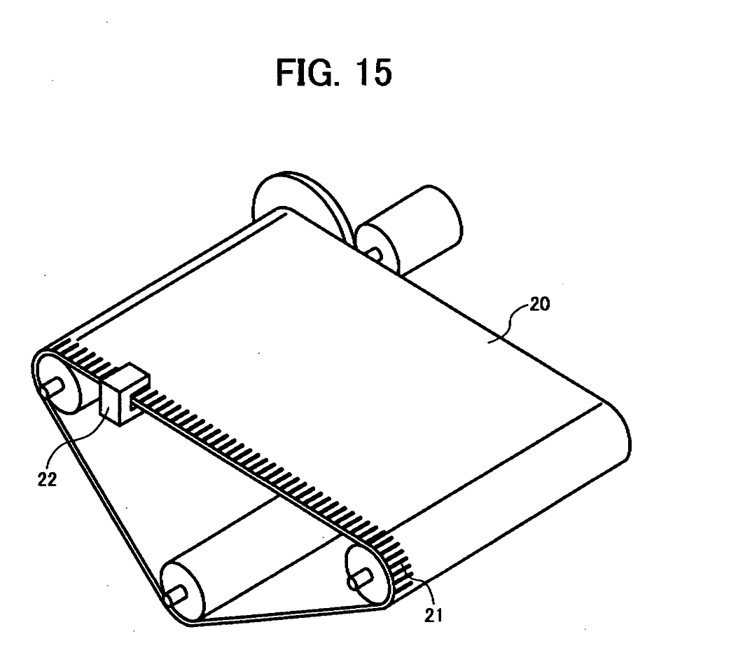

FIG. 11 illustrates an exemplary digital copier of an image forming apparatus according to one embodiment of the present invention. As shown, a digital copier 200 as an image forming apparatus includes a copier body 201, an auto document feeder (ADF) 202, and automatic sorting apparatus 203. The copier body 201 includes an original document reading unit 204, a writing unit 205, an engine section 206, and a sheet feeding unit 207. The original document reading unit 204 includes a carriage 208 having a mirror, a lens 209, a CCD 210, and a buffer 211 to scan and read an original document fed by the ADF 202. The writing unit 205 includes a laser light source and a polygonal mirror to emit a laser beam 212 including image information to the engine section 206. The engine section 206 includes an image formation unit 213, a first unit 214, a second unit 215, and a fixing unit 216.

The image formation unit 213 includes a charger 218 arranged around a photo-conductive member, an emission section receiving the laser beam 212 from the writing unit 214, a color developing section 219 formed from cyan (C), magenta (M), yellow (Y), and black (K) developing units, and a drum clearing section 220. The image formation unit 213 forms a latent image on the photo-conductive member 217 charged by the charger using the laser beam, and visualizes the latent image at the color developing section 219 thereby forming a toner image. The first transfer unit 214 includes an intermediate transfer belt 221, a first transfer section 222, a tension roller 223, a second transfer section 224, a cleaning section 225, and a reference position sensor 226. The first transfer unit 214 firstly transfers a toner image formed on the photoconductive member 217 onto the intermediate transfer belt 212. The intermediate transfer belt 221 serves as a moving member of one embodiment of the present invention, and includes a slit state mark (not shown). Further, the intermediate transfer belt 221 is formed larger than the maximum transfer sheet size (e.g. A3) in the copier 200, and can bear two pages of toner images when a transfer sheet less than A4 size is selected. The intermediate transfer belt 221 is separated from the photoconductive member 217 by a separation mechanism (not shown) other than when firstly transferring a toner image. Specifically, it only contacts the surface of the photoconductive member 217 when firstly transferring the toner image onto the intermediate transfer belt 221. The second transfer unit 215 secondly transfers the toner image transferred onto the intermediate transfer belt 221 onto a recording sheer. The fixing unit 216 fixes the toner image transferred onto the recording sheet with heat and pressure. The sheet feeding unit 207 includes a plurality of sheet feeding cassettes 227a to 227c and a manual tray 228, and feeds a recording sheet to the second transfer unit 215.

The ADF feeds an original document to the original document reading unit 204, and collects the original document read by the original document reading unit 204. The automatic sorting apparatus 203 includes plural steps of sorting bins 229a to 229n and ejects and sorts a plurality of recording sheets each carrying a toner image.

When an image formation cycle starts in the digital copier 200, and an image to form includes a mono color, a toner image is formed on the photo-conductive member 217 with image data read from an original document, and the toner image is firstly transferred onto the intermediate transfer belt 221. The second transfer unit 215 secondary transfers the toner image transferred onto the intermediate transfer belt 221 onto a recording sheet fed in synchronism with the recording sheet. The recording sheet carrying the transferred toner image is fed to the fixing unit 216 and is fixed under the heat and pressure. The recording sheet carrying the fixed toner image is ejected onto the automatic sorting apparatus 203. Further, toner remaining on the intermediate transfer belt 221 is collected at the cleaning section 225.

When an image to form includes more than two mono colors, an original document is read by the original document reading unit 204 with reference to detection of a mark formed on the intermediate transfer belt 221 by the optical sensor 204 as mentioned earlier, image data read is stored in an image memory, a toner image is the formed on the photo-conductive member 217 using the image data, and is firstly transferred onto the intermediate transfer belt 221. Subsequently, a toner image of a second color is formed on the photoconductive member 217 using the image data stored in the image memory, and is firstly transferred onto the intermediate transfer belt 221. Such image formation onto the photoconductive member 217, and first transfer to the intermediate transfer belt 221 is repeated in remaining color formation. Specifically, when a twin color image is formed, the intermediate transfer belt 221 is rotated twice, whereas when a full color image is formed, the intermediate transfer belt 221 is rotated four times.

In any case, toner images formed on the photoconductive member are firstly transferred onto the intermediate transfer belt 221 per rotation to coincide respective images. When a prescribed color toner image is transferred onto the intermediate transfer belt 221, the toner image is secondly transferred onto a recording sheet fed in synchronism with the toner image. The recording sheet is then fixed by the fixing unit 216 with heat and pressure.

Numerous additional modifications and variations of the present invention are possible in light of the above teachings. It is therefore to be understood that within the scope of the appended claims, the present invention may be practiced otherwise than as specifically described herein.

### ADVANTAGE OF THE INVENTION

According to the moving member of the present invention, a mark can be formed while suppressing damage on a base layer of a moving member.

What is claimed is:

1. A moving member having a base layer, comprising:
a first layer configured to block a light having a first wavelength and allow transmission of a light having a second wavelength different from the first wavelength;
a second layer configured to absorb the light having the first wavelength and reflect the light having the second wavelength; and
a third layer configured to allow transmission of the lights having the first and second wavelengths;
wherein said first to third layers are laminated on the base layer in this order.

2. The moving member as claimed in claim 1, wherein said first wavelength ranges within a ultraviolet region, and the second wavelength ranges from a visible region to an infrared region longer than the ultraviolet region.

3. The moving member as claimed in any one of claims 1 and 2, wherein said light having the first wavelength includes irradiation intensity enables the second layer one of to melt, to change characteristics, to modify a property, and to change a shape.

4. The moving member as claimed in claim 1, wherein said first layer includes adhesive having viscoelasticity capable of securing the second and third layers to the base layer.

5. The moving member as claimed in claim 3, wherein said first layer includes adhesive of an acrylic or a silicon type.

6. The moving member as claimed in claim 1, wherein said second layer includes a thin reflection coat made of metal.

7. The moving member as claimed in claim 6, wherein said second layer includes an aluminum thin coat having thickness less than 200 nanometers.

8. The moving member as claimed in claim 1, wherein said third layer includes a plastic film configured to allow transmission of the light having the first wavelength.

9. The moving member as claimed in claim 8, wherein said third layer includes a PET (polyethylene terephtharate) film.

10. The moving member as claimed in claim 1, wherein said base layer includes one of a polyimide film and a composition adjusted polyimide film.

11. The moving member as claimed in claim 1, wherein a reflectivity of said metal thin layer of the second layer is changed by low temperature damaging upon receiving a light having the first wavelength of from 300 nanometer to 400 nanometer with a pulse width less than 100 nanometer.

12. The moving member as claimed in caim 1, wherein said first layer has one of characteristics of absorbing and blocking a light having wavelength from 300 to 400 nanometers, said first layer allowing transmission of a light having a wavelength of from 600 nanometer to 900 nanometer.

13. The moving member as claimed in claim 1, wherein said second layer is processed by the light having the first wavelength to allow transmission of the light having the second wavelength.

14. The moving member as claimed in claim 1, wherein said moving member is formed from an endless belt.

15. The moving member as claimed in claim 14, wherein said endless belt conveys a recording sheet having an image formed.

16. The moving member as claimed in claim 14, wherein said endless belt is formed from an intermediate transfer belt configured to receive transfer of an image.

17. A method for forming a mark on a moving member, comprising the steps of:
providing a moving member having at least three layers;
emitting a light having a first wavelength from the first layer side of the moving member;
forming a mark on a second layer; and
differentiating reflectivity of the mark against a light having a second wavelength different from the first wavelength.

18. An image forming apparatus comprising one of a sheet conveying belt as claimed in claim 15 and an intermediate transfer belt as claimed in claim 16.
